(19) United States
(12) Patent Application Publication
(10) Pub. No.: US 2012/0319475 A1
(43) Pub. Date: Dec. 20, 2012

(54) CONNECTION BASE AND ELECTRIC POWER INTEGRATION APPARATUS HAVING THE SAME

(75) Inventor: YU-HUNG CHENG, NEW TAIPEI CITY (TW)

(73) Assignee: COOLER MASTER CO., LTD., NEW TAIPEI CITY (TW)

(21) Appl. No.: 13/164,342

(22) Filed: Jun. 20, 2011

(51) Int. Cl. H02J 5/00; H02J 9/06

(52) U.S. Cl. 307/19; 307/66

(57) ABSTRACT

A connection base is disclosed. The connection base includes a first connection port, a second connection port, a charging unit, a first electric power conversion unit, and a second electric power conversion unit. The first electric power conversion unit is for converting an input voltage to a first output voltage, and for transmitting the first output voltage to the charging unit. The charging unit is for receiving the first output voltage and outputting a charging voltage, in order to charge the electric power bank device which is detachably connected to the first connection port. The second electric power conversion unit is for receiving and converting a second output voltage of the electric power bank device to a supply voltage, and sending the supply voltage to the inverter which is detachably connected to the second connection port.

### BACKGROUND OF THE INVENTION

1. Field of the Invention

The present invention relates to a connection base and an electric power integration apparatus having the same; in particular, to a connection base facilitating electrical connection for electronic devices, and to an electric power integration apparatus integrating an electric power bank device, an inverter, and the connection base.

2. Description of Related Art

An electric power bank is a device which stores electricity in inner batteries in advance. Electric power outputted by the electric power bank device may be converted into different direct current (DC) voltage levels for different requirements of electronic devices. However, when the DC voltages are provided, the electric power bank device may not simultaneously provide alternating current (AC) voltage to other electronic devices, prompting usage of additional AC power generator and thus at least resulting in inconvenience on the part of human operators.

### SUMMARY OF THE INVENTION

The object of the present invention is to provide a connection base which serves as an intermediate power transmission platform between an electric power bank device and an inverter, for generating both AC power and DC power.

In order to achieve the aforementioned objects, according to an embodiment of the present invention, a connection base including a first connection port, a second connection port, a first electric power conversion unit, a charging unit, and a second electric power conversion unit is disclosed. The first electric power conversion unit converts an input voltage to a first output voltage. The charging unit is coupled to the first electric power conversion unit and the first connection port, for receiving the first output voltage and outputting a charging voltage for charging the electric power bank device which connects to the first connection port. The second electric power conversion unit is coupled to the first connection port and the second connection port, for receiving a second output voltage outputted by the electric power bank device and converting the second output voltage into a supply voltage. The supply voltage is then transmitted to the inverter connected to the second connection port. The first connection port is for detachably connecting to the electric power bank device, while the second connection port is for detachably connecting to the inverter.

When the connection base is connected with the electric power bank device, the connection base may charge the electric power bank device according to the input voltage. In addition, when the connection base is connected with both the electric power bank device and the inverter, the inverter may generate the AC power according to the outputted voltage of the electric power bank device. It is worth noting that the connection base, the electric power bank device, and the inverter are standing alone and could be integrated into an electric power integration apparatus.

On the basis of the above, the connection base according to the embodiment of the present invention may be connected to the electric power bank device only, and may charge the electric power bank device according to the input voltage. The connection base may further connect with the inverter in addition to the electric power bank device for serving as an intermediate power transmission platform between the electric power bank device and the inverter, allowing for the inverter to generate the AC power according to the output voltage of the electric power bank device also. Moreover, the connection base may also be connected with inverter only, in which case the inverter may receive the input voltage transmitted to the connection base and generate the AC electric power output.

Therefore, the inverter and/or the electric power bank device may be connected to the connection base, facilitating different outputs satisfying different requirements of the electronic devices. In addition, because the connection base, the inverter, and the electric power bank device are standing alone devices each of them could be carried around.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a schematic diagram according to an embodiment of the present invention;

FIG. 2 shows a functional block diagram according to an embodiment of the present invention;

FIG. 3 shows a schematic diagram according to another embodiment of the present invention;

FIG. 4 shows a functional block diagram according to another embodiment of the present invention; and

FIG. 5 shows a function block diagram according to still another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

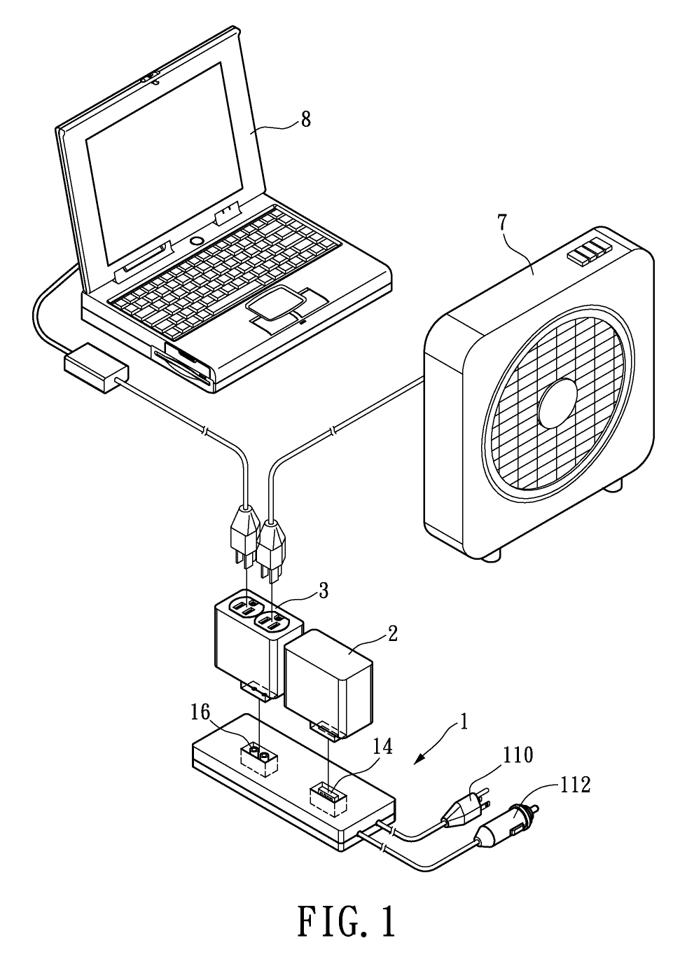

Please refer to FIG. 1. FIG. 1 is a schematic diagram according to an embodiment of the present invention. An electric power integration apparatus includes a connection base 1 having a first connection port 14 and a second connection port 16, an electric power bank device 2, and an inverter 3. In one implementation, the connection base 1, the electric power bank device 2, and the inverter 3 may be standing alone devices. The electric power bank device 2 may be connected to the first connection port 14 of the connection base 1, and the inverter 3 may be connected to the second connection port 16 of the connection base 1. The first connection port 14 may be detachably connecting with the electric power bank device 2, and the second connection port 16 may be detachably connecting with the inverter 3. In one implementation, electrical connection between the electric power bank device 2 and the first connection port 14 may be implemented by common plugs and sockets. Similarly, electrical connection between the inverter 3 and the connection port 16 may also be implemented by plugs and sockets.

As shown in FIG. 1, when the electric power bank device 2 and the inverter 3 are connected to the connection base 1 at the same time, the electric power bank device 2 may provide an electric power with the inverter 3 through the connection base 1. The inverter 3 then generates an alternating current (AC) power according to the electric power provided by the electric power bank device 2. The AC power generated by the inverter 3 may be used by some associated electronic devices, such as a fan 7 or a notebook computer 8.

In addition, the connection base 1 may receive an input voltage from an external source. Then the connection base 1 may charge the electric power bank device 2 according to the input voltage or provide the input voltage to the inverter 3, which in turn may generate the AC power. Meanwhile, the connection base 1 may receive an AC input power from a mains electricity socket (not shown in FIG. 1) through a mains electricity plug 110, or receive a direct current (DC) power from a cigar lighter (not shown in FIG. 1) through a cigar lighter plug 112.

In other words, the connection base 1 may be solely connected to the electric power bank device 2, before charging the electric power bank device 2 according to the input voltage. The connection base 1 in another implementation may also be in connection to both the electric power bank device 2 and the inverter 3, in order to serve as an electric power transmission platform, allowing for the inverter 3 to generate the corresponding AC power according to the output voltage of the electric power bank device 2. In addition, the connection base 1 may connect only with the inverter 3 which generate the AC power according to the input voltage received by the connection base 1.

Therefore, the electric power integration apparatus having the connection base 1, the electric power bank device 2, and the inverter 3 is capable of providing AC and DC electric powers meeting a variety of requirements. Moreover, because the connection base 1, the electric power bank device 2, and the inverter 3 may be standing alone as previously presented either the electric power bank device 2 or inverter 3 or both of them may be carried around at the same time.

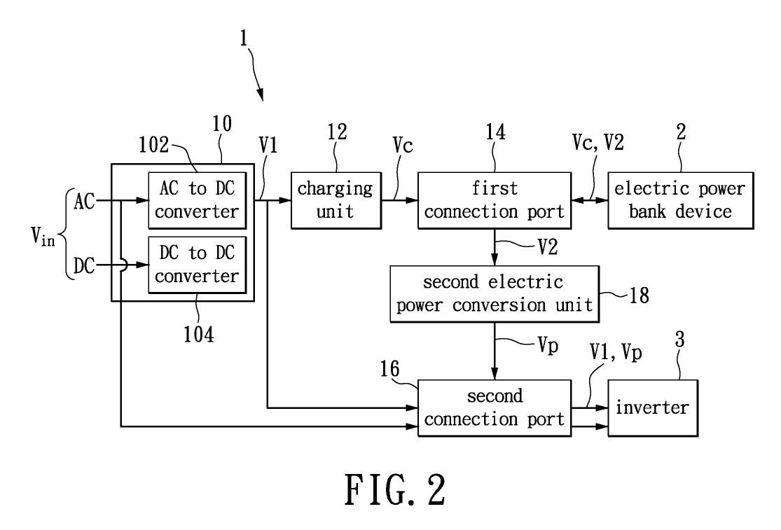

Please refer to FIG. 2 in conjunction with FIG. 1. FIG. 2 is a functional block diagram according to an embodiment of the present invention. The connection base 1 may be used for connecting with the electric power bank device 2, the inverter 3, or other electronic devices. The connection base 1 includes a first electric power conversion unit 10, a charging unit 12, the first connection port 14, the second connection port 16, and a second electric power conversion unit 18. The charging unit 12 may be coupled between the first electric power conversion unit 10 and the first connection port 14. The second electric power conversion unit 18 may be coupled between the first connection port 14 and the second connection port 16. The second connection port 16 may be further coupled to the first electric power conversion unit 10.

The first electric power conversion unit 10 receives an input voltage Vin from external sources. The input voltage Vin includes one of or both of an AC input voltage and a DC input voltage. The first electric power conversion unit 10 may be configured to convert the input voltage Vin into a first output voltage V1, and output the first output voltage V1 to the charging unit 12 and the second connection port 16.

The first electric power conversion unit 10 has an AC to DC converter 102 which is coupled to the mains electricity for converting the AC input voltage to the first output voltage V1. In addition, the first electric power conversion unit 10 may have a DC to DC converter 104 which is coupled to a DC generation device (not shown in FIG. 2). In one implementation, the DC generation device may be a cigar lighter. The DC to DC converter 104 may be used for converting the DC input voltage into the first output voltage V1. The DC to DC converter 104 may be a buck converter. Moreover, the first electric power conversion unit 10 may include both the AC to DC converter 102 and the DC to DC converter 104. Therefore, regardless of the type of the input voltage Vin, conversion from the input voltage Vin into the first output voltage V1 may be performed successfully.

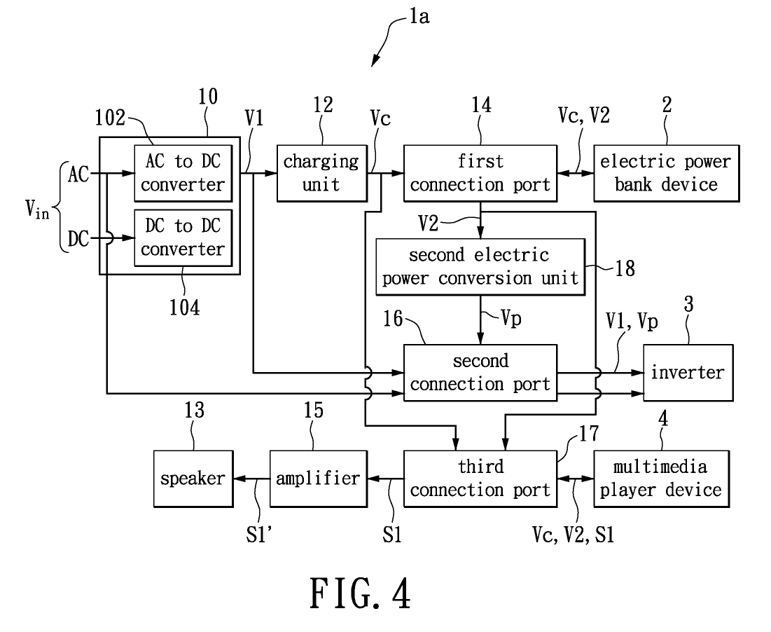

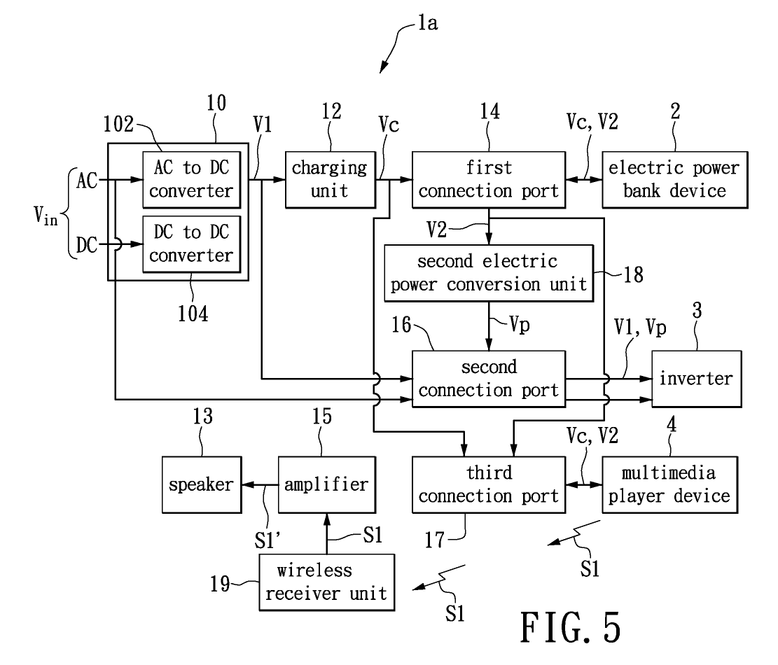

It is worth noting that the first electric power conversion unit 10 may be equipped with a bypass means serving as a transmission path of the electric power between the mains electricity and the second connection port 16. More specifically, the first electric power conversion unit 10 may utilized the bypass means for transmitting the AC input voltage to the inverter 3 connecting to the second connection port 16. In other words, the inverter 3 may thus receive the AC input voltage AC directly before providing the same (i.e., the AC input voltage) with the electronic devices in the absence of the DC to AC conversion. Similarly, the first electric power conversion unit 10 in FIG. 4 and FIG. 5 may have the bypass means for the same purposes of receiving the AC input voltage before providing the same with the electronic devices without the DC to DC conversion.

The charging unit 12 may receive the first output voltage V1 and output a charging voltage Vc to the first connection 14 according to the first output voltage V1, in order to charge the electric power bank device 2 connecting to the first connection port 14. The electric power bank device 2 may be electrically connected to the first connection port 14 by being plugged into the first connection port 14, so that the electric power bank device 2 may receive the charging voltage Vc from the connection base 1.

When the connection base 1 receive no input voltage Vin and both the electric power bank device 2 and the inverter 3 are connected to the connection base 1, the second electric power conversion unit 18 of the connection base 1 may receive a second output voltage V2 outputted by the electric power bank device 2 via the first connection port 14. The second electric power conversion unit 18, meanwhile, may be adapted to convert the second output voltage V2 into a supply voltage Vp, which is further transmitted to the second connection port 16. The transmitted supply voltage Vp may be used by the inverter 3 that is connected to the second connection port 16. Thus, the inverter 3 may generate the AC power according to the received supply voltage Vp. The second electric power conversion unit 18, in one implementation, may be a DC to DC converter with the inverter 3 being the DC to AC converter for converting the supply voltage Vp into the AC power. It is worth noting that the DC to DC converter may be a boost converter.

On the other hand, when the connection base 1 receives the input voltage Vin from the external source and the electric power bank device 2 does not connect with the connection base 1, the first electric power conversion unit 10 of the connection base 1 may transmit the first output voltage V1 to the inverter 3 of the second connection port 16. As such, when the connection base 1 is solely connected to the inverter 3, the inverter 3 may still receive the first output voltage V1 from the first electric power conversion unit 10, and generate the AC power to the electronic devices according to the first output voltage V1 without the electric power bank device 2 supplying the same. The inverter 3, in one implementation, may be a DC to AC converter for converting the first output voltage V1 into the AC voltage.

Additionally, when the connection base 1 receives the input voltage Vin and both the electric power bank device 2 and the inverter 3 are connected to the connection base 1, the first electric power conversion unit 10 of the connection base 1 may transmit the first output voltage V1 to the inverter 3 connecting to the second connection port 16. At the same time, the first electric power conversion unit 10 also transmits the first output voltage V1 to the charging unit 12, which in turn may charge the electric power bank device 2 connecting to the first connection port 14. In other words, when the connection base 1 is connected to both the electric power bank device 2 and the inverter 3, the connection base 1 may simultaneously charge the electric power bank device 2 and provide required electric power with the inverter 3, according to the received input voltage Vin.

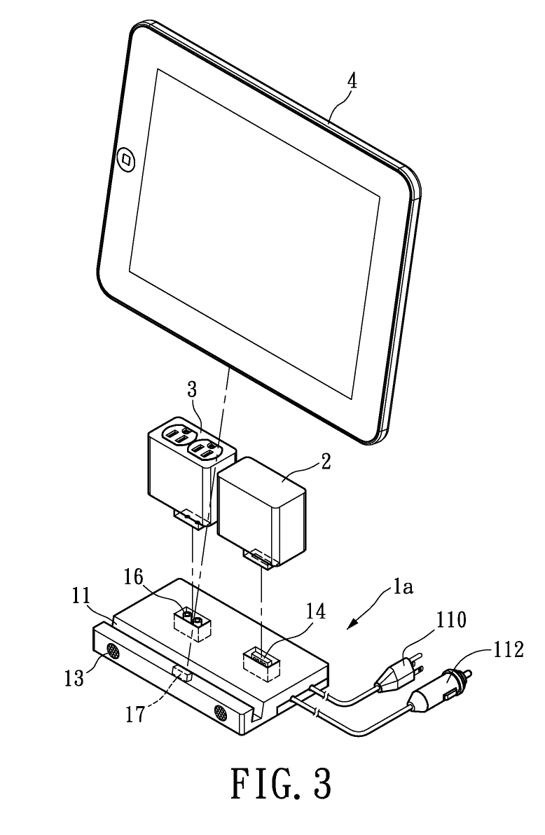

Please refer to FIG. 3. FIG. 3 is a schematic diagram according to another embodiment of the present invention. Compared with the connection base 1 in FIG. 1, the connection base 1a in FIG. 3 further includes a third connection port 17 for connecting a multimedia player device 4. The multimedia player device 4 may be a tablet computer, a smart phone, an MP3 player, or a handheld game console.

The connection base 1a further includes a bearing unit 11 for carrying the multimedia player device 4. The bearing unit 11 may be implemented in terms of grooves and supporting racks when installed on the connection base 1, allowing for the multimedia player device 4 to be placed on the connection base 1 vertically or horizontally.

When the bearing unit 11 in FIG. 3 is a groove structure, the third connection port 17 may be installed at the middle of the groove structure. Therefore, the multimedia player device 4 may be disposed on the connection base 1a vertically or horizontally when uphold by the bearing unit 11 at the time the multimedia player device 4 is connected to the third connection port 17.

Please refer to FIG. 4 in conjunction with FIG. 3. FIG. 4 is a functional block diagram according to another embodiment of the present invention. The third connection port 17 of the connection base 1a may be coupled to the charging unit 12 and the first connection port 14 and may be for connecting with the multimedia player device 4. Thus, when the connection base 1a receives the input voltage Vin and the connection base 1a is connected with the multimedia player device 4 only without connecting to the electric power bank device 2, the charging unit 12 of the connection base 1a may be still capable of outputting the charging voltage Vc to the multimedia player device 4 for the purpose of charging.

In addition, when the connection base 1a receives the input voltage Vin and the connection base 1a is connected to both the multimedia player device 4 and the electric power bank device 2, the charging unit 12 of the connection base 1a may transmit the charging voltage Vc to the multimedia player device 4 and the electric power bank device 2 for charging both the multimedia player device 4 and the electric power bank device 2 at the same time. Moreover, in the processes of charging, a bypass means, such as the transmission path between the charging unit 12 and the third connection port 17, may be provided for bypassing the electric power bank device 2 before transmitting the electric power to the multimedia player device 4.

Furthermore, when the connection base 1a does not receive the input voltage Vin and is simultaneously connected with both the multimedia player device 4 and the electric power bank device 2, the connection base 1a may serve as a platform for the electric power bank device 2 to charge the multimedia player device 4. Accordingly, the electric power bank device 2 may transmit the second output voltage V2 to the multimedia player device 4 through the transmission path of the first connection port 14 and the third connection port 17, for charging the multimedia player device 4.

The connection base 1a may further include an amplifier 15 and a speaker 13. The amplifier 15 may be coupled between the third connection port 17 and the speaker 13. When the multimedia player device 4 is connected to the third connection port 17, the amplifier 15 may receive a sound signal S1 outputted by the multimedia player device 4 from the third connection port 17. After the sound signal S1 is amplified, the amplified sound signal S1′ may be sent to the speaker 13 for the playback of the amplified sound signal.

The connection base 1a has not only the features described in the connection base 1 of FIGS. 1 and 2 but also is equipped with functions of charging the multimedia player device 4 and facilitating the playback of the amplified sound or music originating from the multimedia player device 4.

Please refer to FIG. 5 in conjunction with FIG. 4. FIG. 5 is a circuit functional block diagram according to still another embodiment of the present invention. Compared with the connection base 1a in FIG. 4, the connection base 1b in FIG. 5 further includes a wireless receiver unit 19 with the amplifier 15 coupled between the wireless receiver unit 19 and the speaker 13. The wireless receiver unit 19 of the connection base 1b may be wirelessly connected to the multimedia player device 4. When the connection between the wireless receiver unit 19 and the multimedia player device 4 is established, the wireless receiver unit 19 may receive the sound signal S1 from the multimedia player device 4 before sending the same to the amplifier 15. The amplifier 15 sends the amplified sound signal S1′ to the speaker 13 for the playback of the same.

On the basis of the above, the connection base of the present invention may connect to the electric power bank device only, and may charge the electric power bank device according to the input voltage. In addition, the connection base may connect to both the electric power bank device and the inverter, for serving as the power transmission platform between the electric power bank device and the inverter, which allows for the inverter to generate the AC power according to the outputted voltage of the electric power bank device.

Moreover, the connection base of the present invention may also be connected to the inverter solely on another occasion, in which the inverter receives the input voltage transmitted to the connection base and generates the AC power accordingly. Therefore, the electric power bank device and/or the inverter may connect to the connection base, for enabling flexibility of power output. Furthermore, because of the connection base, the electric power bank device, and the inverter could be as standing alone devices and each of them may be carried around.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

1. A connection base, comprising:
a first connection port configured to detachably connect to an electric power bank device;
a second connection port configured to detachably connect to an inverter;
a first electric power conversion unit configured to convert an input voltage to a first output voltage;
a charging unit coupled to the first electric power conversion unit and the first connection port, wherein the charging unit is configured to convert the first output voltage to a charging voltage and provide the charging voltage to the electric power bank device; and
a second electric power conversion unit coupled to the first connection port and the second connection port, wherein the second electric power conversion unit is configured to receive a second output voltage outputted by the electric power bank device and convert the second output voltage to a supply voltage provided to the inverter through the second connection port.

2. The connection base according to claim 1, wherein the first electric power conversion unit comprises an alternating current (AC) to direct current (DC) converter coupled between an electrical plug and the charging unit.

3. The connection base according to claim 1, wherein the first electric power conversion unit further comprises a direct current (DC) to DC converter coupled between a DC input plug and the charging unit.

4. The connection base according to claim 1, wherein the first electric power conversion unit is coupled to the second connection port and is further configured to output the first output voltage to the inverter.

5. The connection base according to claim 1, wherein the inverter is a direct current (DC) to alternating current (AC) converter configured to convert at least one of the first output voltage or the supply voltage to an AC voltage.

6. The connection base according to claim 1, further comprising a third connection port coupled to the first connection port and configured to connect to a multimedia device, wherein the third connection port is further configured to receive at least one of the charging voltage outputted by the charging unit or the second output voltage outputted by the electric power bank device.

7. The connection base according to claim 6, further comprising an amplifier and a speaker, wherein the amplifier is coupled to the third connection port and the speaker, and the amplifier is configured to amplify a sound signal outputted by the multimedia device to yield an amplified sound signal and send the amplified sound signal to the speaker.

8. The connection base according to claim 7, further comprising a wireless receiver unit configured to receive a sound signal outputted by the multimedia device and provide the sound signal to the amplifier over a wireless connection.

9. The connection base according to claim 6, further comprising a bearing unit configured to carry the multimedia device.

10. An apparatus, comprising:
an electric power bank device;
an inverter; and
a connection base, comprising:
a first connection port configured to detachably connect to the electric power bank device;
a second connection port configured to detachably connect to the inverter;
a first electric power conversion unit configured to convert an input voltage to a first output voltage;
a charging unit coupled to the first electric power conversion unit and the first connection port, wherein the charging unit is configured to receive the first output voltage and output a charging voltage to the electric power bank device; and
a second electric power conversion unit coupled to the first connection port and the second connection port, wherein the second electric power conversion unit is configured to convert a second output voltage outputted by the electric power bank device to a supply voltage provided to the inverter.

11. The apparatus according to claim 10, wherein the connection base further comprises a third connection port coupled to the first connection port, the third connection port configured to couple a multimedia device to the connection base and provide at least one of the charging voltage outputted by the charging unit or the second output voltage outputted by the electric power bank device to the multimedia device.

12. The apparatus according to claim 11, wherein the connection base further comprises an amplifier and a speaker, wherein the amplifier is coupled to the third connection port and the speaker, and the amplifier is configured to amplify a sound signal outputted by the multimedia device to yield an amplified sound signal and send the amplified sound signal to the speaker.

13. The apparatus according to claim 12, further comprising a wireless receiver unit coupled to the amplifier, the wireless receiver unit configured to receive the sound signal outputted by the multimedia device over a wireless connection and send the sound signal to the amplifier.

14. The apparatus according to claim 11, wherein the connection base further comprises a bearing unit configured to carry the multimedia device.

15. A system, comprising:
means for connecting to an electric power bank device;
means for connecting to an inverter;
means for converting an input voltage to a first output voltage;
means for converting the first output voltage to a charging voltage and proving the charging voltage to the electric power bank;
means for converting a second output voltage generated by the electric power bank to a supply voltage and providing the supply voltage to the inverter.

16. The system of claim 15, further comprising means for connecting to a multimedia device and providing the second output voltage to the multimedia device.

17. The system of claim 16, further comprising means for amplifying a sound signal received from the multimedia device yielding an amplified sound signal and providing the amplified sound signal to a speaker.

18. The system of claim 17, further comprising means for wirelessly receiving the sound signal from the multimedia device and providing the sound signal to the means for amplifying.

19. A method, comprising:
converting an input voltage to a first output voltage using a first electric power conversion unit in a connecting base;
converting the first output voltage to a charging voltage using a first electric power conversion unit in the connecting base;
delivering the charging voltage to a first connection port mounted in the connecting base;
converting a second output voltage outputted by an electric power bank attached to the first connection port to a supply voltage; and
providing the supply voltage to a second connection port mounted in the connecting base.

20. The method of claim 19, wherein the converting the input voltage comprises converting the input voltage from an alternating current (AC) voltage to a direct current (DC) voltage.

21. The method of claim 19, wherein the converting the input voltage comprises converting the input voltage from a first direct current (DC) voltage to a second DC voltage.

22. The method of claim 19, further comprising providing the first output voltage to the second connection port.

23. The method of claim 19, wherein the providing the supply voltage comprises providing the supply voltage to an inverter connected to the second connection port.

24. The method of claim 19, further comprising providing the second output voltage to a third connection port mounted in the connection base.

25. The method of claim 24, wherein the providing the second output voltage to the third connection port comprises providing the second output voltage to a multimedia device connected to the third connection port.

26. The method of claim 25, further comprising providing a sound signal from the multimedia device to an amplifier connected to the third communication port.

27. The method of claim 25, further comprising providing a sound signal from the multimedia device to an amplifier over a wireless connection.
